(19) United States
(12) Patent Application Publication
(10) Pub. No.: US 2010/0089903 A1
(43) Pub. Date: Apr. 15, 2010

(54) Cooking Appliance

(75) Inventors: Ingo Bally, Traunstein (DE); Kerstin Feldmann, Bretten (DE); Wolfgang Fuchs, Altenmarkt a.d Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Günter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, MUNCHEN (DE)

(21) Appl. No.: 11/992,218

(22) PCT Filed: Sep. 12, 2006
(86) PCT No.: PCT/EP2006/066280

§ 371 Date: Mar. 18, 2008

(30) Foreign Application Priority Data
Sep. 19, 2005 (DE) 10 2005 044 645.0

(51) Int. Cl. F24C 15/02; F27D 11/00

(52) U.S. Cl. 219/390

(57) ABSTRACT

A cooking appliance, in particular, a cooking appliance which is mounted in an elevated manner, comprising a muffle which defines a cooking chamber and electric and/or electronic components which are arranged inside the door. The electric connection elements are formed by cables, in particular, having strain relief, and at least one part of the cable is received via at least one part of the longitudinal extension thereof in a cable guide, in order to enable a secure cable connection between the electric and/or electronic components in the door and the corresponding connections in the housing, without the cables being guided in an uncontrollable manner in a free chamber of the housing or rub against each other or against additional components inside the housing and as a result become worn.

The present invention relates to a cooking appliance, in particular a high-level built-in cooking appliance, having at least one muffle that delimits a cooking chamber and has a muffle opening, and a displaceable door for closing the muffle opening.

DE 100 59 657 A1 discloses a cooking appliance having a muffle that delimits a cooking chamber and has a muffle opening, a housing for enclosing the muffle, a displaceable door for closing the muffle opening, telescopic guide rods for guiding and displacing the door relative to the muffle opening and electrical and/or electronic components in the form of switches and display devices in the displaceable door. In addition, cables are arranged between at least some of the electrical or electronic components in the door and terminals of, for example, a central control circuit situated at the top in the housing for the purpose of their electrical interconnection, it being generally known to provide contacting in the area of the telescopic guide rods by means of plug connectors and socket outlets and busbars. Plug connectors and socket outlets, however, allow operation only when the cooking appliance is in the completely closed state, while busbars are problematic and complicated in terms of contacting.

It is therefore the object of the present invention to provide a cooking appliance having an improved bridging of the contact section between the door and the housing.

The present object is achieved by means of the cooking appliance having the features recited in claim 1. Advantageous embodiments are the subject matter of dependent claims.

Accordingly, what is preferred is a cooking appliance, in particular a high-level built-in cooking appliance, having a muffle that delimits a cooking chamber and has a muffle opening, a housing for enclosing the muffle, a displaceable door for closing the muffle opening, a guide rod for guiding and displacing the door relative to the muffle opening, and electrical and/or electronic components within the door and electrical connecting elements between the electrical and/or electronic components within the door and terminals in the housing, wherein the electrical connecting elements are embodied by cables, wherein at least some of the cables are accommodated over at least some of their longitudinal extension in a cable guide in order to enable a cable connection from the electrical and/or electronic components in the door to corresponding terminals in the housing in a secure and reliable manner without the cables being routed in an uncontrolled manner in a free space of the housing or rubbing against one another or against further components inside the housing and as a result becoming worn.

It is advantageous in particular that the guide rod is embodied by means of a telescopic guide rod and the cables are guided through same. It is advantageous in particular also that the electrical and/or electronic components are connected by way of the cables to the central control circuit above the muffle in the housing.

It is advantageous in particular that the cable guide is embodied by means of individual guide elements which are spaced apart from one another in the guide rod and/or in a space left free inside the housing.

Advantageous in particular is a cooking appliance wherein the cable guide is embodied by means of a tube, a flexible tube, a coiled cable or a cable guide chain. In addition to a controlled and orderly guiding of the cables this also allows the cables to be protected against rubbing against adjacent cables or further components inside the housing or inside the telescopic rods.

It is preferred that the cable guide guides the cables elastically between an external wall of the muffle and a internal wall of the housing in order to form loops inside the housing and guide same in a controlled manner when the door is closed.

It is advantageous in particular that the cable guide embodies a strain relief for the cables or is arranged by means of a strain relief inside the housing. A strain relief of this kind not only enables the cable guide to be fixed in a controllable manner inside the housing but at the same time also relieves strain on the ends of the cables when the door is drawn out into an open state. In this arrangement the strain relief is preferably disposed so as to be adjustable in the direction of the guide rod. It is also advantageous if the strain relief is adjustable to an unequal and relative extent to the door. This also allows a more selective guiding of the cables or their cable guide inside a space that is left free in the housing.

The invention is described schematically in more detail below with reference to the accompanying figures, in which:

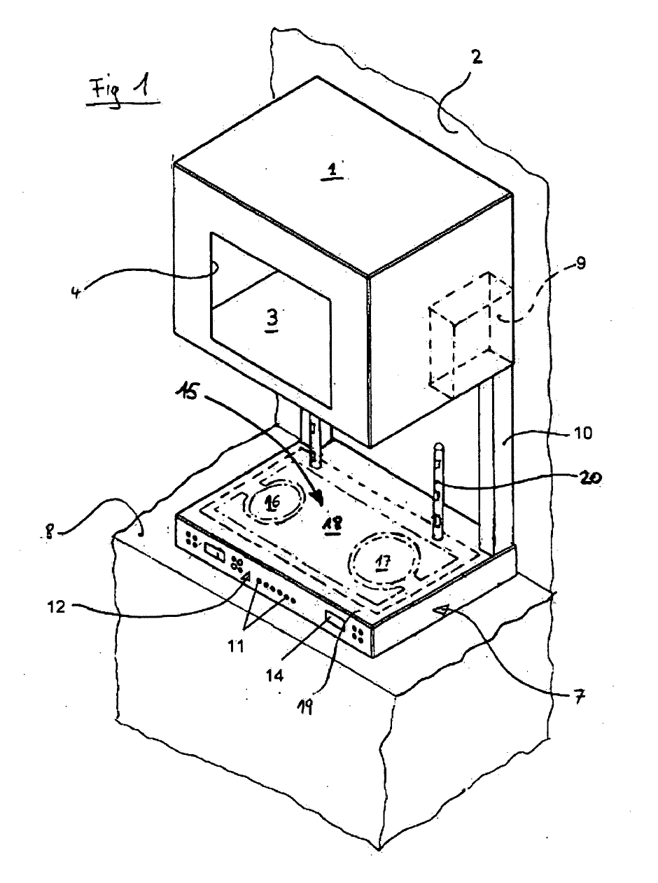

FIG. 1 shows a perspective view of a wall-mounted, high-level built-in cooking appliance with the base door lowered;

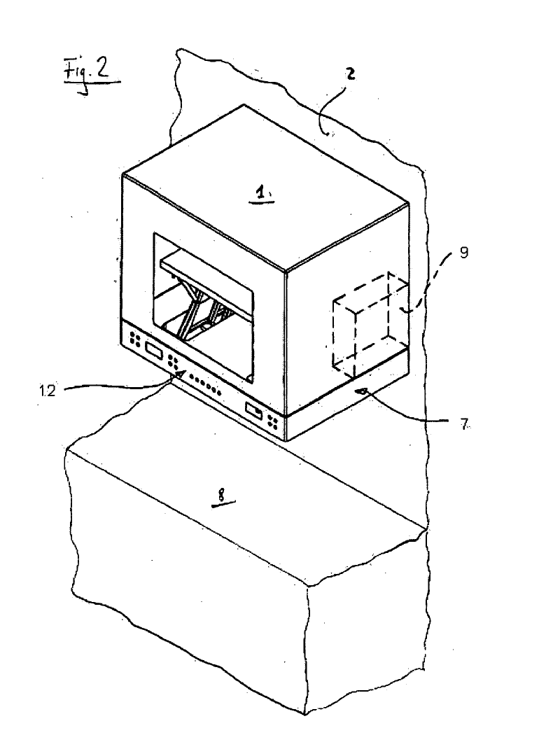

FIG. 2 shows a perspective view of the high-level built-in cooking appliance with the base door closed;

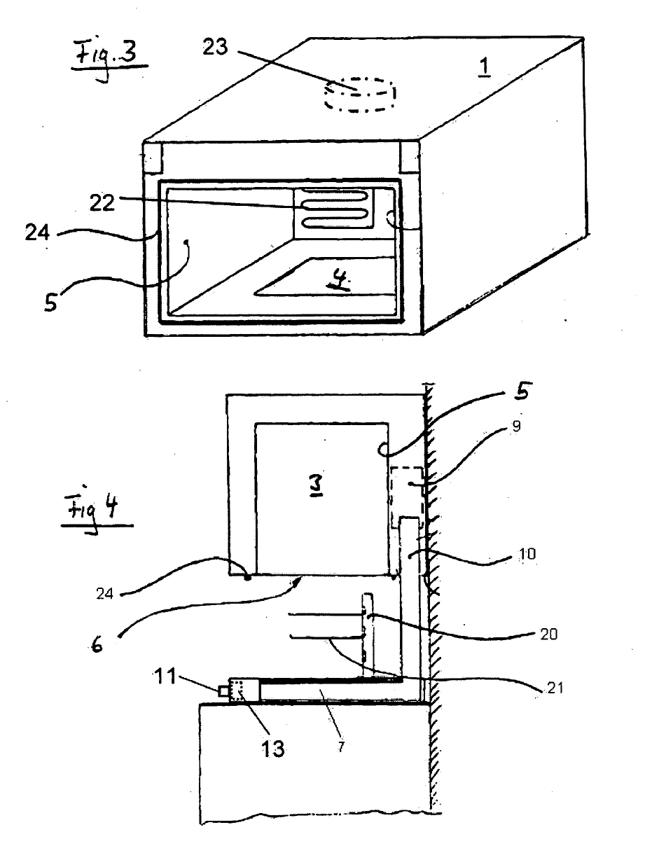

FIG. 3 shows a perspective view of a housing of the high-level built-in cooking appliance without the base door;

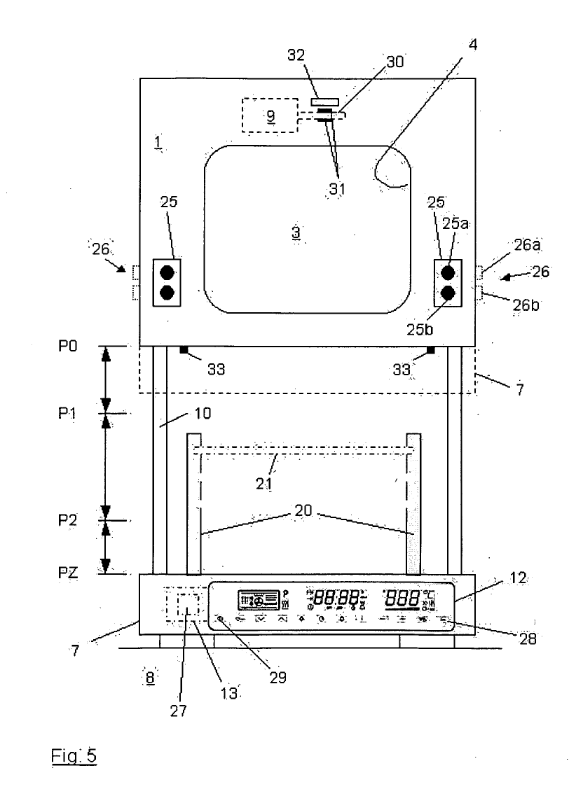

FIG. 4 shows a schematic side view, in cross-section, of the wall-mounted, high-level built-in cooking appliance with the base door lowered;

FIG. 5 shows a front view of a further embodiment variant of a high-level built-in cooking appliance;

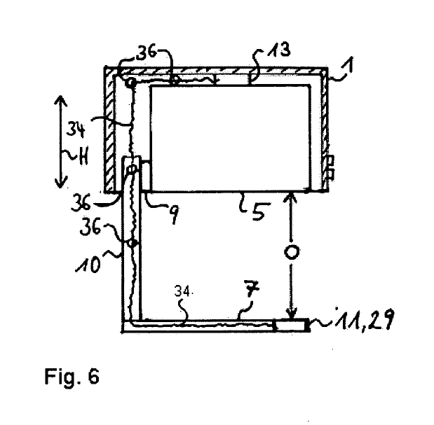

FIG. 6 shows a sectional view of components of a preferred high-level built-in cooking appliance; and

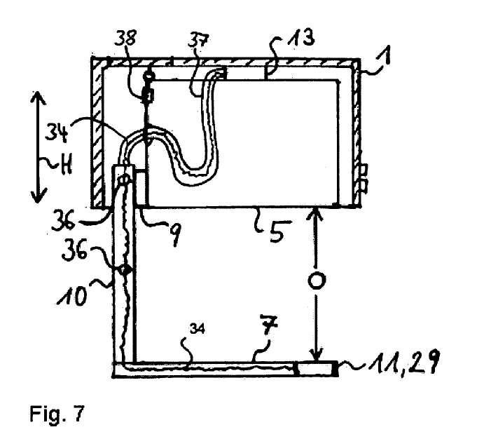

FIG. 7 shows a partial sectional view of an upper part of a high-level built-in cooking appliance according to an alternative embodiment.

FIG. 1 shows a high-level built-in cooking appliance having a housing 1. The rear of the housing 1 is mounted in the manner of a suspended cabinet on a wall 2. Defined in the housing 1 is a cooking chamber 3 that can be monitored through a viewing window 4 provided at the front in the housing 1. It can be seen in FIG. 4 that the cooking chamber 3 is delimited by a muffle 5 which is provided with a thermally insulating casing (not shown) and that the muffle 5 has a muffle opening 6 on its base. The muffle opening 6 can be closed by means of a base door 7. The base door 7 is shown in the lowered position in FIG. 1, resting with its underside on a work surface 8 of an item of kitchen furniture. In order to close the cooking chamber 3 the base door 7 must be moved into the position shown in FIG. 2, which is termed the “zero position”. For the purpose of moving the base door 7 the high-level built-in cooking appliance has a drive device 9, 10. The drive device 9, 10 has a drive motor 9, indicated in FIGS. 1, 2 and 4 by means of dashed lines, which is disposed between the muffle 5 and an exterior wall of the housing 1. The drive motor 9 is disposed in the area of the rear of the housing 1 and, as shown in FIG. 1 or 4, is operatively connected to a pair of lifting elements 10 which are linked to the base door 7. According to the schematic side view shown in FIG. 4 each lifting element 10 is therein embodied as an L-shaped support whose vertical limb extends from the drive motor 9 on the housing side. For moving the base door 7 the drive motor 9 can be actuated with the aid of an operating panel 12 and a control circuit 13, which panel is according to FIGS. 1 and 2 arranged at the front on the base door 7. As shown in FIG. 4, the control circuit 13 is located behind the operating panel 12 inside the base door 7. The control circuit 13, consisting here of a plurality of spatially and functionally separate printed circuit boards that communicate via a communication bus, constitutes a central control unit for operating the appliance and controls and/or regulates, for example, heating, displacing of the base door 3, implementing of user inputs, illuminating, pinching/jamming protection, clocking the heating elements 16, 17, 18, 22, and much more.

It can be seen from FIG. 1 that a top side of the base door 7 has a cooking matrix 15. Virtually the entire surface of the cooking area 15 is occupied by heating elements 16, 17, 18, indicated in FIG. 1 by dash-dotted lines. According to FIG. 1 the heating elements 16, 17 are two differently sized cooking-hob heating elements spaced apart from each other, while the heating element 18 is a panel heating element provided between and almost enclosing the two cooking-hob heating elements 16, 17. For the user, the cooking-hob heating elements 16, 17 define associated cooking zones or cooking rings; together with the panel heating element 18, the cooking-hob heating elements 16, 17 define a bottom-heat zone. The zones can be indicated by means of a suitable decorative motif on the surface. The heating elements 16, 17, 18 can each be controlled via the control circuit 13.

In the exemplary embodiment shown the heating elements 16, 17, 18 are embodied as radiant heating elements covered by a glass ceramic plate 19. The glass ceramic plate 19 has approximately the same dimensions as the top side of the base door 7. The glass ceramic plate 19 is furthermore fitted with mounting openings (not shown) through which protrude bases for fixing securing parts 20 for supports 21 for items being cooked, as also shown in FIG. 4. Instead of a glass ceramic plate 19 it is also possible to employ other—preferably fast-reacting—coverings, for example a thin metal plate.

With the aid of an operating knob provided in the operating panel 12 the high-level built-in cooking appliance can be switched to a cooking-hob operating mode or bottom-heat operating mode, which are explained below.

In the cooking-hob operating mode the cooking-hob heating elements 16, 17 can be controlled individually via the control circuit 13 by means of control elements 11 provided in the operating panel 12, while the panel heating element 18 remains in the non-operating state. The cooking-hob operating mode can be used with the base door 7 lowered, as is shown in FIG. 1. However, it can also be used within the scope of an energy-saving function when the cooking chamber 3 is closed with the base door 7 raised.

In the bottom-heat operating mode not only the cooking-hob heating elements 16, 17 but also the panel heating element 18 are controlled by the control device 13.

In order to achieve maximally even browning of items being cooked during the bottom-heat mode it is critical that the cooking matrix 15 providing the bottom heat should distribute the heating output evenly across the surface of the cooking matrix 15, even though the heating elements 16, 17, 18 have different nominal outputs. The heating elements 16, 17, 18 are therefore preferably not switched to continuous operation by the control circuit 13; instead, the power supply to the heating elements 16, 17, 18 is clocked. The different nominal heat outputs of the heating elements 16, 17, 18 are therein reduced individually in such a way that the heating elements 16, 17, 18 will distribute the heating output evenly across the surface of the cooking matrix 15.

FIG. 4 schematically illustrates the position of a fan 23, for example for producing circulating air in the case of hot-air operation or for ducting fresh air inward. Further provided attached to a top side of the muffle 5 is a top-heat heating element 22 that can be embodied as of single-circuit or multiple-circuit design, for example having an inner and an outer circuit. There can also be further heating elements—not shown here for the sake of greater clarity—, such as a ring-shaped heating element, between the back wall of the housing 1 and the muffle. The various operating modes such as, for example, also top-heat, hot-air, or quick-heat mode can be set by means of the control circuit 13 by appropriately switching or setting the heat output of the heating elements 16, 17, 18, 22, possibly with activating of the fan 23. The heat output can be set by means of suitable clocking. The cooking matrix 15 can furthermore be embodied otherwise, for example with or without a roasting zone, as a pure—single-circuit or multiple-circuit—warming zone without cooking rings, and so forth. The housing 1 has a seal 24 facing toward the base door 7.

The operating panel 12 is normally arranged on the front of the base door 7. Other arrangements are alternatively also conceivable, for example on the front of the housing 1, distributed over different partial panels, and/or in part on side surfaces of the cooking appliance. Further embodiments are possible. The control elements 11 are not limited in their structural design and can include, for example, operating knobs, toggle switches, pushbuttons, and plastic membrane keys that include display elements 14, for example LED, LCD and/or touchscreen displays.

FIG. 5 is a schematic front view (not to scale) of a high-level built-in cooking appliance in which the base door 7 is open and resting on the work surface 8. The closed state is indicated by dashed lines.

In this embodiment there are two displacement switch panels 25 on the front of the permanently attached housing 1. Each displacement switch panel 25 includes two pushbuttons, namely a top CLOSE pushbutton 25a for a base door 7 moving upward in the closing direction and a bottom OPEN pushbutton 25b for a base door 7 moving downward in the opening direction. Without automatic operation (see below) the base door 7 will move upward, if possible, only through continuously simultaneously pressing the CLOSE buttons 25a on both displacement switch panels 25; the base door 7 will also move downward, if possible, only through continuously simultaneously pressing the OPEN buttons 25b on both displacement switch panels 25 (manual operation). Since the user will be more attentive to operation during manual operation and, moreover, both hands are used in that case, pinching/jamming protection will then only be optional. In an alternative embodiment displacement switch panels 26 are attached to opposite outer sides of the housing 1 along with corresponding CLOSE buttons 26a and OPEN buttons 26b, as indicated by dotted lines.

The control circuit 13, which is indicated by dash-dotted lines and located inside the base door 7 behind the operating panel 12, switches the drive motor 9 in such a way that the base door 7 will start moving gently, i.e. not abruptly through simple turning on of the drive motor 9 but by means of a defined ramp.

In this exemplary embodiment the control circuit 13 includes a memory unit 27 for storing at least one target or displacement position P0, P1, P2, PZ of the base door 7, preferably equipped with volatile memory chips, for example DRAMs. After one of the buttons 25a, 25b or, as the case may be, 26a, 26b on the displacement switch panels 25 or, as the case may be, 26 has been actuated, if a target position P0, P1, P2, PZ has been stored the base door can continue moving automatically in the direction set until the next target position has been reached or one of the buttons 25a, 25b or, as the case may be, 26a, 26b has been actuated again (automatic operation). In this exemplary embodiment the bottommost target position, as a final position PZ, corresponds to the maximum opening, the (zero) position P0 corresponds to the closed state, and P1 and P2 are freely selectable intermediate positions. Pinching/jamming protection will preferably have been activated if the base door 7 is displaced in particular in the automatic operating mode. Automatic operation and manual operation are not mutually exclusive.

A target position P0, P1, P2, PZ can be any position of the base door 7 between and including the zero position P0 and the maximum open position PZ. However, the maximum stored open position PZ does not have to be the position resting on the work surface 8. The desired target position P0, P1, P2, PZ requiring to be set is arrived at by, for example,—in this exemplary embodiment—operating the displacement switch panels 25 or 26 with both hands and performing a manual displacement up to said position.

Just one target position or, as shown in this exemplary embodiment, also a plurality of target positions P0, P1, P2, PZ can be stored in the memory unit 27. In the case of a plurality of target positions P0, P1, P2, PZ, these can be moved to consecutively by actuating the corresponding displacement buttons 25a, 25b or, as the case may be, 26a, 26b. A plurality of target positions P0, P1, P2, PZ will allow the high-level built-in cooking appliance to be matched conveniently to the different operating heights desired by a plurality of users. The target position(s) can advantageously be deleted and/or overwritten. In one embodiment, for example, just one target position can be stored in the open state, while the zero position P0 will be detected automatically and can be moved to automatically. Alternatively, the zero position P0 must also be stored so that it can be moved to automatically.

For an ergonomic use it is particularly advantageous for the or a target position P1, P2, PZ to open the base door 7 at least approximately 400 mm to approximately 540 mm (meaning P1-P0, P2-P0, PZ-P0≧40 cm to 54 cm). At this extent of opening the supports 21 for items being cooked can be easily inserted into the securing parts 20. It is favorable in this case for the viewing window 4 to be mounted approximately at the user's eye level or somewhat lower, for example by means of a template indicating the dimensions of the cooking appliance.

A power failure buffer for bridging power outages lasting approximately 1 to 3 s, preferably up to 1.5 s, is present though not illustrated in the drawing.

The drive motor 9 shown in FIG. 1 has at least one sensor unit 31, 32 arranged on a motor shaft 30, where applicable in front of or behind a gear, for the purpose of measuring a displacement path or, as the case may be, a position and/or speed of the base door 7. The sensor unit can include, for example, one or more induction sensors, Hall-effect sensors, optoelectronic sensors, SAW sensors, and so forth. For simple path and speed measurement, two Hall-effect (sub-)elements 31 are here attached to the motor shaft 30 such that they are offset by 180°—i.e. opposite each other—and a Hall-effect sensing element 32 is statically attached at a distance at this area of the motor shaft. When a Hall-effect element 31 then passes the sensing element 32 as the motor shaft 30 rotates, a measuring or sensor signal will be produced that in a good approximation is digital. With (not necessarily) two Hall-effect elements 31, therefore, two signals will be output during one rotation of the motor shaft 30. The speed vL of the base door 7 can be determined by evaluating the time of said signals, for example their time difference, for instance by way of comparison tables or through real-time conversion in the control circuit 13. A displacement path or, as the case may be, a position of the base door 7 can be determined by adding or, as the case may be, subtracting the measurement signals.

A speed-regulating means can implement the speed via, for example, a PWM-controlled power semiconductor device.

For determining the zero point, travel measuring is automatically reset by initializing in the zero position P0 of the base door 7 each time it is moved so that for example a faulty sensor signal output or, as the case may be, pick-up will not propagate.

The drive motor 9 can also be operated by actuating both displacement switch panels 25 or 26 even with the main switch 29 deactivated.

Instead of two separate switches per displacement panel 25, 26, a single switch per displacement panel is also possible, for example a toggle switch that has a neutral position and switches only under pressure. Other forms are also possible. The nature and arrangement of the control elements 28, 29 of the operating panel 12 are not limited, either.

The arrangement of the control circuit 13 and the way it is distributed is therein flexible and not limited, so it can also include a plurality of boards, for example a display board, a control board, and a lift board, which are spatially separated.

A 4-mm opening extent can be detected by means of end switches 33 which on actuation deactivate pinching/jamming protection.

The high-level built-in cooking appliance can also be embodied without a memory unit 27, in which case automatic operation is then not possible. This can be expedient for increased operating safety, for example as a safeguard against pinching/jamming.

FIG. 6 shows components in the area of the muffle 5 and the cooking chamber 3 of a preferred high-level built-in cooking appliance, wherein cables 34 run between electrical and/or electronic components 11, 29 inside the base door 7 and a control circuit 13 at the top between the muffle 5 and an internal wall of the housing 1. In the fully withdrawn state of the door 7, the cables 34 are preferably fully extended, as sketched in the drawing, though still arranged without a tensile load on the contact points with the control circuit 13 and the electrical and/or electronic components 11, 27. The figure depicts a situation with an extent of opening O of the door 7 below the housing 1 greater than an installation height H of the housing 1 itself, which is made possible by the use of the lifting elements 10 embodied as telescopic guide rods. When the door 7 is parked or the muffle opening 6 closed by means of the door 7, the upper sections of the cables 34 are displaced into a correspondingly free space 35 between the muffle 5 and the internal wall of the housing 1. To ensure the cables are not damaged and in particular a plurality of cables 34 adjacent to one another are not shifted so as to become chaotically entwined, at least some of the cables 34 are housed and routed in a cable guide 36.

As can be seen from FIG. 6, the cable guide can in this case be embodied by means of simple individual guide elements that are spaced apart from one another.

FIG. 7 shows a partial sectional view of an upper part of a high-level built-in cooking appliance according to an alternative embodiment. In this particularly preferred embodiment the cables 34 are routed through a cable guide 36 implemented as a flexible tube, coiled cable or preferably as a cable guide chain 37. In this case the cable guide chain 37 again runs between an external wall of the muffle 5 and an internal wall, adjacent thereto, of the housing 1. A space 35 that is left free is again adequately dimensioned so as to provide sufficient room for accommodating the entire length of cable in the fully parked state of the door 7 in which the muffle opening 6 is closed.

As can be seen in FIG. 7, also provided in addition to the cable guide in the form of a cable guide chain 37 is a strain relief 38 which is realized in a particularly simple embodiment by means of a loop which encompasses the cable guide 37 and which provides a means of fixing the cable guide at an exterior fixing point on the muffle 5 or by means of an interior fixing point on an internal wall of the housing 1. According to a particularly preferred embodied of a strain relief of this kind it is taken into account that when the door 7 is moved upward from the telescopic guide rod 10 in the form of the lifting element into the free space 35, cables are pushed upward, with the loop which encompasses the cable guide chain 37 being mounted in a height-adjustable manner in the housing 1. In this case the height of the loop is adjusted for the purpose of raising the cable guide chain 37 and hence the cables 34 routed therein. It can preferably be provided that the travel distance of the loop of a strain relief 38 of this kind is less than the simultaneous travel distance of the door 7 in order thereby to support a loop formation of the cable guide inside the free space 35.

As a result of using cables 34 for connecting electrical and electronic components 11, 27 in the door 7 to the central control circuit 13 above the muffle 5 it is made possible not only to provide a cable protection means when a cable guide is used, but at the same time also to make the base door 7 suitable for use in principle also in the open state for controlling components inside the housing 1 and/or for controlling components inside the door 7.

The outside or walls of the muffle can also be referred to as a housing body, with insulating layers typically being fitted between the housing body and the muffle interior—with the exception of the front side equipped with viewing windows.

List of Reference Signs
1 Housing
2 Wall
3 Cooking chamber
4 Viewing window
5 Muffle
6 Muffle opening
7 Base door
8 Work surface
9 Drive motor
10 Lifting element
11 Control element
12 Operating panel
13 Control circuit
14 Display elements
15 Cooking matrix
16 Cooking hob heating element
17 Cooking hob heating element
18 Panel heating element
19 Glass ceramic plate
20 Securing part
21 Support for items being cooked
22 Top-heat heating element
23 Fan
24 Seal
25 Displacement switch panel
25a Displacement switch, upward
25b Displacement switch, downward
26 Displacement switch panel
26a Displacement switch, upward
26b Displacement switch, downward
27 Memory unit
28 Confirmation button
29 Main switch
30 Motor shaft
31 Hall-effect element
32 Sensing element
33 End switch
34 Cables
35 Cable guide
36 Cable guide chain
36 Strain relief
P0 Zero position
P1 Intermediate position
P2 Intermediate position
PZ Final position
vL Displacement speed of the base door

1-11. (canceled)

12. A cooking appliance comprising:
a cooking chamber;
a muffle which delimits the cooking chamber; the muffle having a muffle opening;
a housing enclosing a substantial portion of the muffle;
a displaceable door for closing the muffle opening;
a guide rod for guiding and displacing the door relative to the muffle opening;
electrical and/or electronic components located inside the door; terminals located in the housing; electrical connecting elements for connecting the electrical and/or electronic components to the terminals;
the electrical connecting elements include at least one cable; a cable guide; at least a portion of at least one cable being housed in the cable guide.

13. The cooking appliance as claimed in claim 12 wherein the cooking appliance is a high-level built-in cooking appliance, and the door is a base door for the high-level built-in cooking appliance.

14. The cooking appliance as claimed in claim 12 wherein the guide rod is telescopic and at least a portion of at least one cable is routed through the guide rod.

15. The cooking appliance as claimed in claim 12 further including a central control circuit located in the housing; the electrical and/or electronic components are connected to the central control circuit by at least one cable.

16. The cooking appliance as claimed in claim 12 wherein the cable guide includes individual spaced apart guide elements.

17. The cooking appliance as claimed in claim 12 further including free space inside the housing; the cable guide located in the free space.

18. The cooking appliance as claimed in claim 12 wherein the cable guide includes a tube.

19. The cooking appliance as claimed in claim 18 wherein the tube is flexible.

20. The cooking appliance as claimed in claim 12 wherein the cable guide includes a coiled cable.

21. The cooking appliance as claimed in claim 12 wherein the cable guide includes a cable guide chain.

22. The cooking appliance as claimed in claim 12 wherein the muffle includes an external wall and the housing includes an internal wall; the cable guide guides at least one cable between the external wall of the muffle and the internal wall of the housing in a deformable manner.

23. The cooking appliance as claimed in claim 12 further including a strain relief associated with at least one cable.

24. The cooking appliance as claimed in claim 23 wherein the strain relief is connected to the cable guide.
